(19) United States
(12) Patent Application Publication
(10) Pub. No.: US 2008/0306782 A1
(43) Pub. Date: Dec. 11, 2008

(54) Method of Driving Traffic From a Mobile Wireless Device to an E-Commerce Site and Tracking that Traffic

(75) Inventor: Eithan Ephrati, London (GB)

Correspondence Address: FOX ROTHSCHILD LLP, P O BOX 592, 112 NASSAU STREET, PRINCETON, NJ, 08542-0592, US

(73) Assignee: CELLECTIVITY LIMITED, London (GB)

(21) Appl. No.: 11/720,916

(22) PCT Filed: Dec. 6, 2005
(86) PCT No.: PCT/GB05/04669

§ 371 Date: Nov. 20, 2007

(30) Foreign Application Priority Data
Dec. 6, 2004 (GB) 0426735.7
Mar. 4, 2005 (GB) 0504526.5

(51) Int. Cl. G06Q 30/00; G06Q 10/00

(52) U.S. Cl. 705/7; 705/1

(57) ABSTRACT

An entity registers as an affiliate of an e-commerce site and then publishes information that promotes that WWW e-commerce site; an end-user with a mobile wireless device, sees that information and as a consequence sends a request to a remote server that can interact with the e-commerce site under control inputs from an application running on the device. The request includes data that uniquely defines the affiliate. This approach makes is easy to become an affiliate able to drive traffic from a mobile wireless device to a WWW e-commerce site; this is based on the re-use of existing affiliate management systems (previously not thought relevant to the m-commerce environment). Further, the mechanism for creating traffic for a WWW e-commerce site is easy; it just involves an affiliate publishing certain information. Still further, it is easy to track interactions between a mobile wireless device and a WWW e-commerce site and link them to appropriate affiliates; this is again based on the re-use of existing affiliate management systems (previously not thought relevant to the m-commerce environment). Finally, it is easy to pay affiliates, as well as the infrastructure operator that runs the remote server, since both can be paid using the existing affiliate management systems (again, previously not thought relevant to the m-commerce environment).

### BACKGROUND OF THE INVENTION

1. Field of the invention

This invention relates to a method of enabling traffic to be driven and tracked to an e-commerce site, the traffic relating to interactions between the e-commerce site and a mobile wireless device. Traffic is driven to an e-commerce site when an end-user does not visit that site directly but instead visits another site (or any kind of information carrying channel or media, including online, mobile or offline) first and as a consequence of that visit goes on to interact with the e-commerce site. Tracking occurs when the interactions between an end-user and the e-commerce site can be logged or measured in some manner; tracking also includes monitoring, which usually refers to real-time logging or measurement.

The term ‘e-commerce site’ will be used to refer to a WWW site that offers goods or services for end-users.

The term ‘mobile wireless device’ covers any device which can send data and/or voice over a long range wireless communication system, such as GSM, GPRS or 3G. It covers such devices in any form factor, including conventional mobile telephones, PDAs, smart phones and communicators.

2. Description of the Prior Art

Navigating on the World Wide Web (using a web browser on a PC) relies on an HTML hyperlink in a web page; when this hyperlink is selected it re-directs the browser to fetch a different WWW (i.e. web) site, defined by a new URL that is based on the hyperlink. The new URL itself does not merely include the host of the destination web site (e.g. the domain name of the server that hosts the destination web site), but can include a great deal of further information, including information defining the source web site as well (sometimes referred to as the anchor). Hence, if one types ‘books’ as a search query into Google, you will get a list of hits returned, and the URL may look like:

http://www.goggle.co.uk/search?num=20&hs=JHZ&hl=en&safe=off&client=firefox-a&rls=org,mozilla%3Aen-US%3Aofficial s&q=books&btnG=Search&meta=

You can tell from this a fair bit of information about the query and the browser used. If one selects the link to one of the paid-for advertisements (perhaps Amazon), one automatically gets redirected to the related web site. The URL might then be:

http://www.amazon.co.uk/exec/obidos/search-handle-url/index%3Dbooks-uk%26field-keywords%3Dbooks%26results-process%3Ddefault%26dispatch%3Dsearch/ref%3Dpd%5Fsl%5Faw%5Ftops-2%5Fbooks-uk%5F6561722%5F2/202-6319787-6482263

This includes information (known as a URL tracking code) that tells Amazon that the URL request came from a Google paid for advertisement. In this scenario, Amazon might actually pay Google a small amount of money because one clicked through from its advertisement that appeared in the Google results for the ‘Books’ search to the Amazon site. This is an example of an ‘affiliates program’.

In the World Wide Web, remuneration is often based on this kind of a model, in which ‘affiliates’ drive visitor traffic to e-merchants with e-commerce web sites and are paid on a commission basis using a computer implemented ‘affiliates management system’; affiliates can also access multiple e-merchants through aggregators that act as an exchange or marketplace where e-merchants and affiliates meet. Any member in the ‘affiliation chain’ may track the traffic his site is generating for different e-commerce sites using a web-based tracking system.

To Re-Cap on the Terminology:

Affiliate—An entity with the ability to drive new consumers/visitors and new business to an existing e-merchant; it includes webmasters, portals, online marketers, community moderators, search engines etc. Affiliates are sometimes called ‘distribution partners’. The term ‘affiliate’ or ‘distribution partner’ covers any media or partner that encourages end-users to seek out an existing e-merchant by advertising or promoting on different media such as: internet content sites, TV, radio, billboards, opt in DB's, WAP portals, on deck applications etc

E-Merchant—An online transactional e-commerce site wishing to attract new clients and business to its site.

Affiliate Management System—The computer implemented system that an e-merchant deploys to enable entities to become affiliates and to enable those affiliates that drive traffic to its e-commerce site to be identified by allocating to them a unique tracking identifier, such as a URL tracking code.

Affiliate Program—The incentive scheme implemented by the Affiliate Management Program. All affiliate programs are results driven, either by visits, sales, revenue share or new registrants.

Affiliate Aggregator and Exchange—Aggregators bring together multiple merchants, Exchanges facilitate a merchant/publisher meeting place.

Affiliate Tracking System—A tool allowing the affiliates and the e-merchants to monitor (sometimes in real time) campaign results. Generally, it is the e-Merchant that tracks in detail—they allocate the URL tracking codes and track activity against it. Affiliates may also track (e.g. they can track that the user clicked on a link, but not much more e.g. whether they went on to buy). Affiliates can also require tracking on the ‘landing page’—usually a hidden pixel that effectively calls-back to the affiliate to know that the user ‘landed’. Tracking may involve real-time tracking, or tracking with results fed back within a few minutes or hours.

Hence, the technical infrastructure set up to allow a referring web site to be identified by the destination e-commerce web site and hence paid for each visit, registrant or sale (respectively, pay-per-click; pay-per lead; pay-per sale) is called an affiliate management system. Affiliate management systems include a web based interface that readily allows any potential referring site to automatically participate in the affiliate program through a simple registration form that results in the allocation of an affiliate URL tracking code to that affiliate. In turn, the affiliate can then embed its affiliate URL tracking code in any URL/link that he uses in order to promote the destination e-commerce site (directly, or indirectly). This code allows the tracking system to monitor the activity generated by this affiliate.

This commission based paradigm to driving traffic to e-commerce web sites has become very important in the economy of the World Wide Web. Where the referring site is one of the major web search engines, then, as noted earlier, a listing of a given e-commerce site might only be present because it has been paid for; whenever an end-user clicks from the listing to the e-commerce site, the search engine gets paid. This drives the income of companies such as Google, Inc. In this context, Google would be an affiliate of the site that it drives traffic to.

This affiliates model has yet to be adopted in the mobile wireless space because implementing it seemed technically impossible; one barrier is the difficulty in verifiably establishing the identity of the entity that drove specific traffic to a specific e-commerce site, over wireless communications network using wireless specific languages and protocols—i.e. the difficulty in including tracking codes for mobile telephony based interactions with conventional WWW e-commerce sites.

More generally, interacting with e-commerce sites using a mobile telephone (sometimes called m-commerce) has in the past been very limited. Manual browsing, web spiders, web scraping and direct data feeds are known approaches. Of these, direct data feeds are well established, but have the disadvantages of being expensive, requiring time consuming and often complex IT integration and exposing existing systems to security vulnerabilities. Direct feeds also preclude any kind of affiliates program and usually may not enable a two way commercial transaction. Few mobile network operators built e-commerce sites using this direct feed approach; they were adopting a so-called ‘walled garden’ approach, in which users of one network would engage in mobile commerce solely with entities within the control borders of that network.

WAP based e-commerce sites should in theory be an effective way of enabling mobile telephones to interact with on-line sites, but there are very few WAP sites of any interest to consumers, not least because it can be costly for a merchant to replicate a web site to give a WAP presence. WAP navigation also precludes any kind of affiliate program because the URLs in WAP are length limited and hence it is impossible in practice to reliably include within the URL of a destination WAP site any indication of the source WAP site that the end-user is navigating from. It is thus also impossible to use several redirects for the same link. Moreover, WAP links may be used to navigate only within WAP pages (and not WWW sites), which are rare and hard to find.

The technical challenge is therefore to be able to allow mobile wireless devices to interact with conventional WWW based e-commerce sites that can be browsed by a PC web browser, and, in addition, to implement some kind of tracking functionality that makes it possible to work out why traffic is driven to a given e-commerce site and what kind of interactions does that traffic represent; this would enable an affiliates management system to be built for m-commerce (i.e. mobile telephones interacting with e-commerce sites). But to date, even the possibility of deploying an affiliates program and related management system for the m-commerce space has not been appreciated.

The present applicant introduced a new technology, called Web Agents, in PCT/GB02/03702 (equivalently EP 1419459, the contents of which are incorporated by reference) that enables a more effective process of software interacting with e-commerce sites. Web Agents technology is a framework that allows easy, rapid and robust implementation of extremely lightweight software components that automate browsing on the web. The main idea behind the framework is to look at the web as a huge cluster of databases. It uses a transfer protocol support to link itself to and perform actions on such a “database”. It also queries the “database” using a query language, in order to extract information from it. In a Web Agents implementation, the mobile telephone does not interact directly with an e-commerce site, but instead with a remote server. It is the server that deploys the Web Agents framework and directly interacts with the e-commerce web site, sending results back to the mobile telephone to display. PCT/GB02/03702 does not however disclose any kind of tracking functionality that makes it possible to work out why traffic is arriving at a given e-commerce site and hence does not disclose any kind of affiliates management system suitable for mobile wireless devices.

### SUMMARY OF THE PRESENT INVENTION

In a first aspect, the invention is a method of enabling traffic to be driven to an e-commerce site, and that traffic tracked, the traffic relating to interactions between the e-commerce site and a mobile wireless device; the method comprising the steps of:
(a) an entity registering as an affiliate of the e-commerce site and publishing information that promotes that e-commerce site;
(b) an end-user seeing that information and as a consequence sending, or causing to be sent, a request to a remote server that can interact with the e-commerce site under control inputs from an application running on the device, the request including data that uniquely defines the affiliate.

In practice, there will be many thousands, perhaps tens of thousands of affiliates seeking to push traffic to the more successful e-commerce sites. When you factor in there being thousands of highly successful sites, and millions of sites that still justify some level of traffic directing effort, then the practical problem of establishing which particular affiliate out of this huge universe is responsible for initiating a given item of traffic (e.g. a particular visit from a mobile wireless device to a given site; or an individual registering at a given site or buying one item from a site) and the downstream problem, of monitoring all subsequent interactions is quite huge.

Hence, the invention addresses the technical problem of establishing the identity of a referral entity and tracking the interactions between an end-user with a mobile wireless device and an e-commerce site that are a consequence of that referral. It permits the reliable, automated identification of the entity (possibly the first entity, but not necessarily) in the causal chain of entities that leads the mobile wireless device to reach a particular destination e-commerce site and interact with that site. The term ‘identity’ should be broadly construed to cover some information uniquely linked to the entity and that enables the entity to be directly or indirectly established. It may simply be a unique number, which does not of itself reveal the name of the identity (see below). The request is a request/query that indicates that the end-user wishes to interact with an e-commerce site in some manner.

Prior to this invention, mobile wireless devices have interacted with e-commerce sites (i.e. WWW sites) using specialised Web Agents technology, but without there being any mechanism to enable traffic to be driven to a specific e-commerce site from an affiliate and for that traffic to be tracked.

Furthermore, the entity can interact directly with an affiliates management system associated with the e-commerce site to become an affiliate. This in turn allows the e-commerce site to remunerate the entity directly using its well established web affiliates program. This can be done with no alteration to the existing web affiliates program or the affiliate management system of an e-merchant; indeed the merchant may well be completely unaware that it is happening and need incur no costs in changing its technical infrastructure or integrating its e-commerce site with any third party technology.

Furthermore, by implementing a Web Agents type intelligent system that allows a server to interact directly and fully with an e-commerce site, passing back data for the mobile wireless device to display, it is possible for an existing, e-commerce site (i.e. a WWW site designed for non-wireless web browsing) itself to require no adaptation at all for effective interaction with mobile wireless devices.

The present invention can be implemented using any way of publishing the information; in practice, however there are three main ways:
Offline channel (e.g. a magazine, newspaper, billboard, TV, Radio or other print or digital media—i.e. anything that is not online (i.e. internet connected) or mobile (wireless WAN connected)—see below;
Online channel (a channel that requires an internet connected PC with a web browser looking at web content, e.g. a banner advert on a web site, links, forms, content, keyword advertising on a web site etc.);
Mobile channel (a channel that requires a wireless WAN connected mobile computing device looking at non-web, mobile specific content, e.g. WAP portals, mobile operators' on deck applications, J2ME applications, off deck portals, WAP Push, opt-in DB's MMS etc.)

We will briefly deal with each in turn. First, offline; the information that is published offline can be a unique identifier comprising at least a destination number, the unique identifier being associated with both the given e-commerce site and the entity. Then:
(a) the end-user uses the mobile wireless device to send a message to the destination number to initiate an interaction with the e-commerce site;
(b) a remote server then interacts directly with the e-commerce site but enables the end-user to interact only indirectly with that site using the downloaded application;
(c) the identity of the entity is established using the unique identifier.

The unique identifier can be a unique code or text (the ‘key word’), as well as the destination number (the ‘short code’). The unique text can be conceptually related to the goods or services offered by the e-commerce site. Hence, an affiliate could log onto a conventional computer implemented affiliates management system for an online retailer that sells National Lottery tickets and register as a new affiliate. That system gives the entity a unique affiliate number 123 and a unique identifier that the affiliate can use in promoting the National Lottery to mobile telephone users; this identifier is the key words ‘Get Lucky’ and a SMS short code number 686874. The phrase ‘Get Lucky’ (or some other slogan etc.) could instead be devised by the affiliate entity itself and provided to the affiliates program. In this scenario, the ‘identity’ is the number 123, the ‘unique identifier’ is ‘Get Lucky’ and the ‘destination number’ is short code 686874. The affiliate could publish a newspaper advert for the National Lottery, reading “Text ‘Get Lucky’, to 686874 to play the National Lottery on your mobile”. The ‘Get Lucky’ key word uniquely identifies this particular affiliate to the remote server (the server itself is contactable via the network operator who routes the message to the remote server); the server knows that any end-user texting in this phrase is doing so because of seeing the newspaper advert placed by this particular affiliate (different affiliates would usually have different key words, and would therefore be distinguishable). Any end-user (identified by the mobile wireless device's telephone number) can be linked to this affiliate; the remote server and also the affiliate can hence track future interactions by that end-user with the National Lottery web site. Consequently, that affiliate can be paid on a normal affiliates basis. To actually interact, the mobile wireless device needs the client application that gives the control inputs to the remote server. This could be downloaded to the device as a consequence of the ‘Get Lucky’ text, or could already be installed. The application could also be pre-installed on a mobile device at the time of sale.

Where the information is published on-line by an affiliate on a WWW site, then the information can include an icon, button or other user selectable feature that, when selected, causes the application to be downloaded to the mobile wireless device. Selecting the user selectable feature also fetches an implementation page that explains how the user should install the application on the mobile wireless device. In this example, the data that uniquely defines the affiliate is a URL tracking code. The National Lottery affiliate could for example be given URL tracking code XX-123-ZZ for a particular online campaign for a particular new lottery product. This tracking code is used in the request sent by the online affiliate's site to the remote server; the end-user's mobile telephone number is also entered into the affiliate's web site and sent to the remote server. The remote server links the mobile telephone number to that particular affiliate, allowing all future interactions to be tracked, reported to the affiliate and used as the basis for commission payments.

Where the information is published in using a mobile channel (e.g. a WAP site, so that the end-user views that site using a WAP browser on the mobile wireless device), then the WAP site includes a hyperlink that, when selected, causes the application to be downloaded to the mobile wireless device. The data that uniquely defines the affiliate is a URL tracking code. This is used in the same way as for the on-line example.

To re-cap, the request from the end-user can, in one implementation, be sent to a remote server that stores the number of the mobile wireless device of the end-user in association with a tracking code that links that end-user to a specific affiliate. This remote server sends an application (a J2ME application typically) to the mobile wireless device, which the device loads to enable the end-user to interact indirectly with the e-commerce site. Alternatively, the application can be pre-installed on the device, or have been installed earlier. The remote server can identify not only the affiliate responsible for causing an end-user to send the request that identifies the affiliate, but also a specific campaign/promotion that the affiliate has initiated, and can track all interactions for each end-user, relating them to a particular affiliate.

The remote server can also interact directly with an affiliates management system associated with the e-commerce site; the affiliates management system causes a payment to be made to the entity that operates the remote server when pre-defined kinds of interactions occur between the end-user and the e-commerce site. The affiliates management system can also cause a payment to be made to the affiliate when pre-defined kinds of interactions occur between the end-user and the e-commerce site. This eliminates the need for a costly and complex billing infrastructure, with attendant IT integration issues.

An e-commerce merchant can therefore publish a web traffic affiliate program online using an affiliate management system and any potential affiliate can register online with that program, not only for conventional web traffic promotion but also in relation to interactions from mobile wireless devices mediated by the remote server. Hence, the entry barriers to a WWW based e-commerce merchant entering into mobile commerce are substantially removed. Furthermore, powerful tracking features are enabled; for instance, the request sent by the end-user to the remote server can uniquely identify a campaign or product being promoted by the affiliate. The traffic that is driven to the e-commerce site includes traffic relating to one or more of: the end-user visiting the e-commerce site; the end-user registering with the e-commerce site; the end-user purchasing goods or services from the e-commerce site. The affiliates management system allows the e-merchant and any affiliates to monitor or track the success and detailed activity of any specific marketing campaign. With an implementation of the present invention, it is possible to track anything the user does after he first requests the download of the application to his mobile wireless device. But more importantly, the affiliation tracking system knows which campaign this user has come from: e.g.—that an advertising campaign in Canary Wharf, London for a particular betting product on a particular e-commerce site has generated 100 initial requests, which in turn resulted in 20 application downloads, which in turn resulted in 15 full registrations, with which the end-users on the average bet 535 50 a week. Or, for example after two days of a banner advertisement on Yahoo.com, the affiliate that sponsored this banner can see that it results in registration of women betting only few pounds—driving him to change to a more “male oriented” banner.

Another feature is that the application that is loaded onto the mobile wireless device provides a user interface that enables the end-user to interact indirectly with the e-commerce site. The user interface is created by a presentation layer that allows customisation of the user interface for any different e-commerce site. The remote server remotely interrogates one or more e-commerce sites in response to information requests from the application loaded onto the mobile wireless device; it can not only parse data on the site but also interact with transactional flows or routines of that site. The remote server can deploy Web Agents; it then includes a query engine which operates on XML format data obtained from content data extracted from the e-commerce site, the query engine parsing the XML format data into SAX events which are then queried by the query engine. Web Agents allow the end-user to interact indirectly with the e-commerce site, including undertaking one or more of the following: account creation, login/out, searching, browsing, account maintenance, purchasing. This interaction from the remote server requires no adaptation of an existing e-commerce site; entry barriers previously preventing a WWW based e-commerce site from entering into mobile commerce can hence now be removed.

Other aspects of the invention are as follows:
A printed publication that promotes an e-commerce site and is controlled by an entity that is an affiliate of that e-commerce site, the publication including a unique identifier that, when sent, or caused to be sent, by an end-user to a remote server using a mobile wireless device, uniquely defines the affiliate.
A web site that promotes an e-commerce site and is controlled by an entity that is an affiliate of that e-commerce site, in which the web site includes an icon, button or other user selectable feature that, when selected, causes a request to be sent to a remote server, the request uniquely defining the affiliate.
A WAP site that promotes an e-commerce site and is controlled by an entity that is an affiliate of that e-commerce site, in which the web site includes an icon, button or other user selectable feature that, when selected, causes a request to be sent to a remote server, the request uniquely defining the affiliate.
A mobile wireless device when programmed with an application downloaded because of an interaction with the printed publication, web site or WAP site defined above.
A method of remunerating an affiliate via an affiliate program, in which the affiliate produces the printed, online or WAP publication defined above.
An affiliate remunerated using the method of remuneration defined above.

Overall, the present invention is a significant enabler for mobile commerce between mobile wireless devices and WWW e-commerce sites because:
It makes is easy to become an affiliate able to drive traffic from a mobile wireless device to a WWW e-commerce site; this is based on the re-use of existing affiliate management systems (previously not thought relevant to the m-commerce environment);
The mechanism for creating traffic for a WWW e-commerce site is easy; it just involves an affiliate publishing certain information;
It is easy to track interactions between a mobile wireless device and a WWW e-commerce site and link them to appropriate affiliates; this is again based on the re-use of existing affiliate management systems (previously not thought relevant to the m-commerce environment);
It is easy to pay affiliates, as well as the infrastructure operator that runs the Web Agents server, since both can be paid using the existing affiliate management systems (previously not thought relevant to the m-commerce environment).

### BRIEF DESCRIPTION OF THE DRAWINGS

The present invention will be described with reference to the accompanying drawings in which

FIG. 1 is a schematic of the overall process and flow of the present invention;

FIG. 2 is a schematic showing the relationship between merchants, affiliates, users and the operator of the remote server infrastructure (Cellectivity);

FIG. 3-10 are screen shots from an Affiliates Management System offered by Cellectivity.

### DETAILED DESCRIPTION

The present invention provides a system and method to enable a mobile wireless device to interact with e-commerce sites. It enables e-commerce sites to be promoted (e.g. online, WAP, printed media such as billboards, adverts in papers etc) using a novel mechanism that allows the identity of an entity that successfully drives traffic to an e-commerce site to be reliably identified. This is a necessary pre-condition to entities becoming affiliates. But an added feature of the invention is that it can implement the entire web-based affiliation process in the mobile space; it hence enables affiliates to be remunerated on a commission basis (e.g. pay-per-click, pay-per-lead, pay-per-sale, revenue share etc.).

An implementation comprises 4 main features:
1. Remote integration—In the non-mobile space (e.g. HTML based web sites) it is easy for a potential affiliate to integrate into a merchant's e-commerce site as that entity just adds a link that points to that e-commerce site in the entity's own site; a user can, using a web browser, then easily navigate from one the entity's site to that merchant's site by clicking on the link. But in the mobile space, this cannot be done straight forwardly: it requires either direct access to the e-merchants' back-end system, or requires the merchant to build a mobile dedicated UI. The Web Agents technology (see below) does allow remote integration to a merchant's site from a mobile wireless device and, because of a presentation layer (see below) it also allows use of the existing web based UI of that site.
2. Remote transaction: again, this is very easy on the Web as the user is on the merchant site (or sometime a white-label of the merchant site). The Web Agents technology enables remote transactions between a mobile telephone and an e-commerce site via a remote server that deploys the Web Agents technology; it is this server and not the mobile telephone that interacts directly with the e-commerce site.
3. Tracking system On the web, tracking is achieved by using a URL tracking code that is added to a link, so that the original web site that is linked to the merchant's e-commerce site (i.e. clicking on the link initiated the transfer to the merchant's e-commerce site) can be uniquely identified. This enables the e-commerce site to identify the source of hits on its site. This in turn enables revenue share/commission payments to be made back to the original referring site. In the mobile space, we either use URL tracking to download an application from our servers (not the merchant's e-commerce site) or we use a novel solution: a unique text string or other kind of unique identifier which is sent (typically via SMS) to a defined destination number (n.b. both the string and/or the destination number can serve as the unique identifier). This identifier uniquely identifies the affiliate.

4. Downloading an application to the mobile telephone is one variant of the integration process—an end-user sees a publication (e.g. online advertisement, paper advertisement etc.) promoting particular goods or services or a particular merchant(s). The publication might, using he earlier example, be a billboard or TV advert with the words:
“Text ‘Get lucky’ to 68684’ to pay the National Lottery”

The publication includes a unique identifier, which could be a specific destination number to which a message should be sent (68684 alone in the example above); the unique identifier could also include the message to be sent as well (the phrase ‘Get Lucky’ as well as the destination number 68684).

The end-user sends a SMS (or similar) text message including the unique key word identifier code (e.g. ‘Get Lucky’) from his mobile telephone to the short code destination number (or else a blank message to the destination number if that number alone serves as the unique identifier) and an application is automatically sent to and loads on his mobile telephone. In the above example, it is an application that allows the end-user to play the National Lottery—e g. choose a set of numbers, pay for them and be notified automatically if they are winning numbers. Many other applications are possible, e.g. a betting application could allow an end-user to choose a sport (football, horse racing etc.), obtain odds from different bookmakers, place a bet and collect winnings.

The unique identifier gives the remote server (and/or some other resource) the information it needs to establish the identity of the entity responsible for the publication (e.g. the affiliate, such as which particular magazine or web site etc.). The remote server (and/or some other resource) can hence maintain a database log of all affiliates and what kind and level of traffic each generates and for which destination e-commerce sites and which campaign/which product or service. The local application downloaded to the mobile telephone takes care of the rest of the entire process by sending instructions to the remote server; the instructions in turn run the Web Agents technology that resides on the remote server. Responses back to the remote server, from the e-commerce site or sites being interacted with, are in turn processed by the remote server and then fed back by the server to the mobile telephone for appropriate display. Because the local application includes a flexible presentation layer that determines the user interface presented on the mobile telephone, it is also possible for this user interface (e.g. the arrangement and layout of icons, fields, buttons, text and graphics, plus the way of interacting with any of the above) to mimic the user interface that would be presented to the end-user if he were to interact directly with the e-commerce site using a PC with browser over a conventional wire based WAN, as opposed to a mobile telephone using predominantly a wireless WAN.

More on a Web Agents Implementation

The Web Agents technology enables a mobile telephone or other mobile wireless device to interact with web resources in a sophisticated manner, enabling an end-user to undertake many different kinds of e-commerce transactions. The Web Agents technology can automatically search across different web sites, query and interact (read and write) with those sites and, as required, return information to the end-user or perform tasks on her behalf. Reference should be made to PCT/GB2002/003702, the contents of which are incorporated by reference. This discloses a web interaction system comprises a query engine which operates on XML format data obtained from content data extracted from a web site, the query engine parsing the XML format data into SAX events which are then queried by the query engine.

One of the drawbacks of this system however is that it does not provide for the automatic identification of how an end-user came to visit a particular e-commerce site—e.g. how was the end-user prompted to visit a particular e-commerce site. It is in effect silent on any kind of mechanism for tracking how traffic for a given site was in fact generated. Further, it requires a complex billing system to pay the operator or other entity responsible for running the remote server that interacts with the e-commerce site. The present invention addresses the former (as noted above) by defining a new mechanism that does allow entities that promote successfully an e-commerce site to be identified reliably and for all subsequent interaction to be tracked; it addresses the latter by proposing a remuneration infrastructure—i.e. that the existing affiliates management system normally used for web sites that drive traffic through hyperlinks can also be adopted as the payment mechanism for the operator of the remote server, as well as the mechanism for setting up affiliates and paying them.

Conventional affiliates management systems are used to reward web sites that direct traffic to a web merchant's conventional web site. Once directed to that web site, the PC based end-user then interacts with the web site in the normal way. With Web Agents technology, the end-user does not interact directly with a merchant's web site in the way a PC based end-user would—instead, the Web Agents technology searches across multiple sites and extracts out the critical data needed for an interaction from a mobile telephone, making the interaction far simpler. The end-user can complete the entire transaction without needing to visit the actual merchant web site; critically, the entity that makes the search and interaction possible (e.g. a mobile operator offering the Web Agents service) can itself be paid not by directly billing the end-user (which would require a complex billing infrastructure) but instead by using the affiliates program of that merchant. A web merchant's affiliates payment program system has not previously been used as the payment infrastructure for a service that locates goods/services requested from a mobile telephone and enables an end-user to complete an entire transaction from the mobile telephone without the end-user having to directly visit and interact with the merchant's web site. Instead, they have only been used to pay entities that refer traffic to that web site using HTML hyperlinks over a non-wireless link and then go on to interact with the web site.

But with the present invention, the service that locates goods/services (and operates the remote server running Web Agents) can hence readily be remunerated by a web merchant when an end-user using the service interacts with the web merchant (e.g. registers with that merchant, initiates an e-commerce action such as buying goods or placing a bet etc.) The mechanism used can be simple: the service itself registers as an affiliate on the affiliate program offered by the web merchant. The service is allocated automatically a unique label or tag by the affiliate's management system; whenever the service interacts with that merchant's e-commerce site on behalf of an end-user, all interactions use this tag. Hence, the merchant and service have a detailed record of all visits, new customers, new sales etc. generated by the service. This record can be the basis for payment on the standard affiliates basis (pay-per-lead, pay-per-click; pay-per-sale).

In addition, the service can also pass back some of this remuneration (or otherwise pay) to the entity that directed an end-user to use the service in the first place. This ability to remunerate the entity that typically promotes the service is very important since without it the ability to effectively promote the service is severely limited. Alternatively, the entity can itself directly register as an affiliate with one or more merchants' affiliates programs.

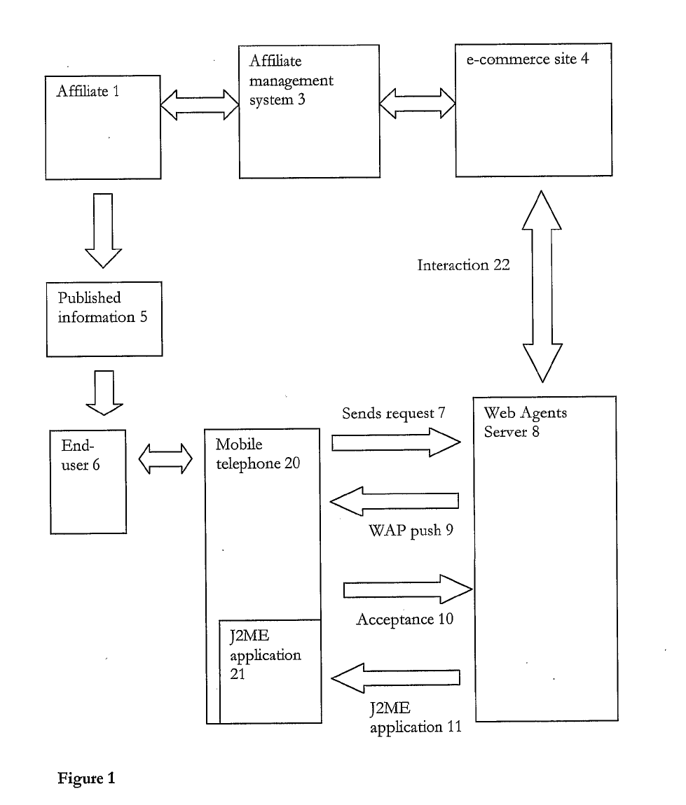

One mechanism used to enable the service to identify the promoting entity and track the consequential or subsequent interactions between an end-user and an e-commerce site. This is shown schematically in FIG. 1: the promoting entity 1 first registers 2 on-line using a web based management system 3 of a merchant with an e-commerce site 4. In the offline channel model, the affiliate selects or is given a word or number by the service; this word or number is unique to a given entity and features in all promotional material 5 for the service from that entity, with the instruction that a potential end-user 6 should text 7 the word or number to the service/remote server 8 to initiate the entire web interaction process using their mobile telephone 20. For example, imagine that there are 2 different entities that are promoting the same e-commerce betting services via the mobile telephone. In the adverts in a campaign from one entity, the end-user 6 is told to text the word ‘win’ to a given number. In the adverts for the other, the end-user is told to text the word ‘lucky’ to the same number. The entities 1 could be different search engines, newspapers/magazines, or different organizations etc. Each text is received by the service 8 that locates goods/services and operates the remote Web Agents server; it can hence differentiate between end-users that have come to it from each different entity. The service 8 logs the mobile telephone number of the telephone 20, and stores this together with the data in request 7 that uniquely identifies each affiliate 1 (and in this case, a particular campaign for a particular e-commerce site from a particular affiliate). Any subsequent interactions from this mobile telephone number for this betting e-commerce site can hence be associated with a specific affiliate 1 and particular campaign. Receipt of the text request 7 from a given mobile telephone triggers the service 8 to send a WAP push link 9 to the device; if the end-user 6 accepts the link, then an acceptance message 10 is returned to the service 8. This causes service 8 to send out a J2ME application to the mobile telephone 20; this loads on the mobile telephone 20, as shown at 21, and provides the user interface that enables the end-user to efficiently interact with web resources 4 via Web Agents technology deployed by the remote server 8. The loaded J2ME application 21 communicates in background with the remote server 8. The presentation layer of the JME application 21 is configured to mimic the UI of the e-commerce site 4 being indirectly interacted with.

In one implementation, a mobile telephone user 6 sends a request 11 for goods and services using the local J2ME application 21 that it downloaded to his mobile telephone 20 after seeing a particular advertisement 5 etc. The request 11 uses a protocol which is device and bearer agnostic (i.e. is not specific to any one kind of device or bearer) and is sent over the wireless network (e.g. GSM, GPRS or 3G) operated by a mobile telephone operator (e.g. Vodafone). The request is directed to the operator, who then routes it through to the remote server 8 (typically operated by an independent company specializing in designing the software running on such servers, such as Cellectivity Limited), which initiates a search through appropriate suppliers 4 by using the above described Web Agents web interaction system.

The Web Agents web interaction system 8 automates the entire web browsing process which a user would normally have to undertake manually. The user in effect delegates tasks to the web interaction system 8, eliminating the need for continued real time connection to the Internet. The search may also depend on business logic set by the operator—e.g. it may be limited to suppliers who have entered into commercial arrangements with the mobile telephone operator controlling the web interaction system.

The web interaction system 8 interacts 22 with the e-commerce site web resources 4 (not simply WAP, iMode or other wireless protocol specific sites), querying them, submitting forms to them (e.g. password entry forms) and returning results to the translation engine. The translation engine converts the results content (usually HTML, but the system is not limited to that content language) into properly nested XML by generating SAX events; the query engine then applies appropriate queries to the SAX events in order to extract the required information and generally interact with the web site in a way that simulates how a user would manually browse through and interrogate the site in order to assess whether it offers goods/services of interest and to actually order those goods/services.

The objective is for the consumer experience to be a highly simplified one, using predefined user preferences in order to make sure that the goods/services offered to the consumer are highly likely to appeal.

The kind of traffic received at an e-commerce site can be monitored by the site itself, but can also be monitored by the remote server. This can give an independent audit trail of events. Typical traffic data stored includes the nature of the interaction (e.g. new customer registering, new purchase, just a browse) plus other information such as the length of time spent on the site, amount of money spent, identity of the remote server that inter-mediated the transaction, the identity of the entity that published the promotion/advert/information that initiated the downloading of the application to a mobile telephone that in turn enabled the web interaction via the remote server to take place etc. This data in turn is fed to the affiliates payment system of the merchant, triggering an automated payment to the promoting entity; the amount depends on the kind of affiliate relationship entered into. Affiliates (which can include the remote server as well) can at any time track the volume of traffic they are generating and for whom and can hence fine tune/adapt any marketing campaigns to improve results. Because data capture is entirely automatic, it can happen very rapidly, enabling an affiliate to adapt a promotional campaign very rapidly—perhaps within hours or days. This kind of rapid feedback would be extremely costly to implement conventionally, requiring costly and time consuming IT integration. Annex II is a system requirements document for an Affiliate Management and Reporting System that can be deployed with the present invention.

Annex 1

Web Agents in More Detail

The Web: A Virtual Database

E-merchants maintain highly available web interfaces for their inventory. In essence, each interface Web-site) is a semantic representation of the merchant's dumb data which also captures the merchant's business and transactional flows. Using unique software components, Web Agents are able to capture and interact with these abstraction layers. This allows the remote server that deploys Web Agents to operate the internet as its own virtual data-base in real time. This is done to the extent where most of the functions that commercial data management tools provide over a traditional data-base (e.g. Oracle) are supported in this virtual data-base. In turn it allows the automation of complex tasks for the benefit of the end-user. A payment transaction can be completed without the need for feedback from the user and without the continued connection to the client. In principle, the end-user delegates demanding tasks to the application and waits for its fulfilment, resulting in a simple and efficient user experience. This requires no technical integration with the individual web sites.

Application/Logic Layer

This mostly includes business services which are re-useable across multiple applications, a few specific business rules, and the logic of individual applications. In addition, the logic employs personalization and decision making tools to filter information according to the end-user profile. This design allows the rapid development of entirely new applications.

The behaviour of each application is determined by two factors: the preferences and profile of the end-user, and the business rules set by the mobile operator. The company uses its own internal SDK to develop new applications rapidly.

Presentation

The key feature of the presentation layer is the separation of the consumer experience (user flow) from the application logic. This feature allows one to customise the consumer experience to the specifications of each mobile operator. The presentation layer is also responsible for detecting the optimal content presentation for the protocol and device combination, and for acting as a controller for push and pull services to the client. This presentation layer allows us to efficiently deploy applications across past and future protocols and to provide extensive customisation opportunities.

The advantage of the Web Agents technology can be summarized as follows:
Identifies and interacts with the semantics and flow of web interfaces
Retrieves information which cannot just be scraped (e.g. showing the user only available flights at a certain moment, requiring a complex multi-step interaction with the web-site that cannot be mimicked by parsing alone)
Starts and completes commercial transactions without requiring any dedicated effort (or even awareness) on the vendor's behalf
Is robust to syntactical changes on the web (e.g. different wording, location of text, etc.)
Automatically identifies changes in logic (user flow or semantic) on the web
Uses the standard IP address of the vendor (usually designed for high-availability, and continuously monitored) to communicate
Exploits the entire functionality of the vendor's site, including purchasing, log in/out, account creation and maintenance, search, browsing
Able to access any functionality added or any problems corrected by the vendor.
Flexible and takes advantage of any changes on the vendor's side such as promotions etc. which may appear on the site but not through a feed of bare data.
Launches within weeks rather than years

Annex I

This Annex will outline the functional requirements for an affiliate managements system operated by Cellectivity Limited.

The system is required to gather essential information from various sources and combine it in ways useful for all user groups to consume. This Annex will cover reports required by all user groups and derive what is the information needed to assemble those reports.

System User Definitions

This section will define the system user types in terms of their interaction with the system and how they are identified through out.

Application Users

Application users are individuals interacting with the system using mobile phones. This is done either via WAP portals, by sending SMS messages, or via mobile applications.

Users are identified by their mobile telephone number. When a user is referred by another portal their telephone number may not always be passed along, in which case they would be asked to provide it and it will need to be verified by an SMS or password if they already exist on the system.

Application users are likely to be referred by affiliates in which case they would be assigned to the referring affiliate and their actions will be reflected in the appropriate affiliate reports.

Merchants (Partners)

Merchants are providers of services, which are made available to mobile users via mobile applications, through the Cellectivity network (i.e. the network that places the Web Agents server at its core). They may provide their own applications or the applications could be developed by Cellectivity and interact with the merchant's system.

Merchant's revenue is shared with Cellectivity according to different deal structures, which are described further in this document.

Merchants are identified by unique merchant ids assigned to them by Cellectivity.

Affiliates

Affiliates are application distributors who refer users to Cellectivity's network. They generate revenue based on the users' actions and the affiliate agreements.

Affiliates are identified by Cellectivity assigned Affiliate ids. In some cases they need to be separately identified on merchants' networks, by merchant affiliate ids, which are linked to the Cellectivity ids.

Apart from standard affiliates there will also be merchant affiliates. These will be used, when the merchant is marketing the applications themselves. These affiliate accounts will not be paid out, but there revenues will be deducted from the amount the merchants are invoiced.

Internal Users

Internal users administer the internal systems and extract relevant information.

It is required that there are various access levels available.

User Interaction

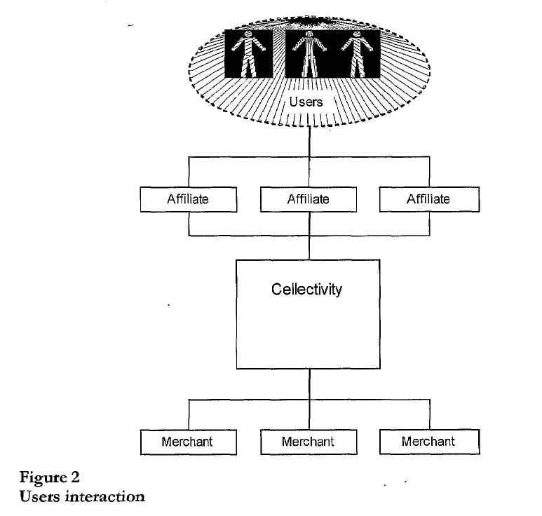

Users are referred by affiliates via SMS and/or the affiliates' mobile portals. For SMS referrals the affiliates are assigned unique per application keywords for their users to send to short numbers resulting in a WAP push of the URL containing the requested application. The FIG. 2 diagram below represents the typical user interaction: an application user referred by an affiliate downloads a merchant's application from Cellectivity.

If a user is referred via SMS, this means that they have sent the affiliate short code to the number requesting a particular application. Since the short codes are unique per affiliate the system will be aware who the referring affiliate is. The telephone number of the user will be extracted from the database. It will be logged in the database and a unique identifier will be assigned to the number, which will identify the user to belong to the referring affiliate for that application.

If the downloaded application is Cellectivity's then all actions by the user are logged as the application interacts with the servers. If the application belongs to a third party, they are required to provide daily updates of user actions to be included in the affiliate reports.

Deal Structures

This section will outline the various merchant and affiliate deal structures.

The deal structures refer to the actions performed by the system users, which trigger payments to be made between merchants, Cellectivity and affiliates.

Merchant Deal Structures

There are different merchant deal structures, specific to the verticals the merchants operate in. The deal structures outline the payments to be received by Cellectivity based on the users' actions.

Betting

Bounty

A bounty is a payment for a bet placed by a user. It is required for the system to allow flexibility in terms of which transactions generate a bounty for different merchants. I.e. a merchant may pay the bounty amounts for the first and the fourth bets made by a user, while another merchant may pay bounties on bets five and nine.

Share of Ongoing Revenue

The share of the ongoing revenue could be one of the following:
Percentage of the total stake regardless of the bet outcome. This could be paid either immediately or after the event has occurred.
percentage of revenue, which is calculated per affiliate on a monthly basis as house wins—house losses—tax. These will always be paid after the event.

The system will need to support different commission figures for users who had signed up for accounts directly with the merchants prior to using the affiliate applications.

Shopping

Per Transaction

Shopping merchants pay commission per transaction, the commission could be either a percentage of the transaction cost or a set amount.

It is required for the system to support volume based commission structures. I.e. for the first 100 sales the commission is x, for any sales after the commission would be y.

Per Lead

Merchants may pay per clicks to their website.

Dating

New Users

For new users signing up via the mobile application the merchants will pay a percentage of the subscription fees.

Existing Users

If the users already have a subscription to the dating service and wish to use the mobile applications merchants will pay a percentage of the monthly subscription for that month.

Casino/Poker

Merchants will pay commissions on monthly revenues per affiliate.

Revenue=house wins—house losses—taxes

Q: Are the subtracted taxes different between different merchants?

The commissions paid will be different based on weather the application is promoted by the merchant.

Affiliate Deal Structures

The system will support different affiliate structures, which can be combined for one affiliate distributing multiple applications.

Pay Per Click

The Affiliate is paid per click for any users, who click through from their site to a merchant.

Pay Per Download

The Affiliate is paid when a user they have referred downloads a merchants' application.

Pay Per Registration

The affiliate will receive payment once their user registers with Cellectivity or a merchant

Pay Per First Transaction

The affiliate will receive payment once the user executes the first transaction with a merchant.

Revenue Share

The affiliate will receive a share of the revenue on an ongoing basis.

In this case the affiliate will receive revenue only for new users they have referred and not for users with existing accounts.

Reporting Requirements

Affiliate Reporting

The affiliate reporting interface will be an external web based reporting interface accessible via http. Affiliates will be required to supply their username and password to access the interface.

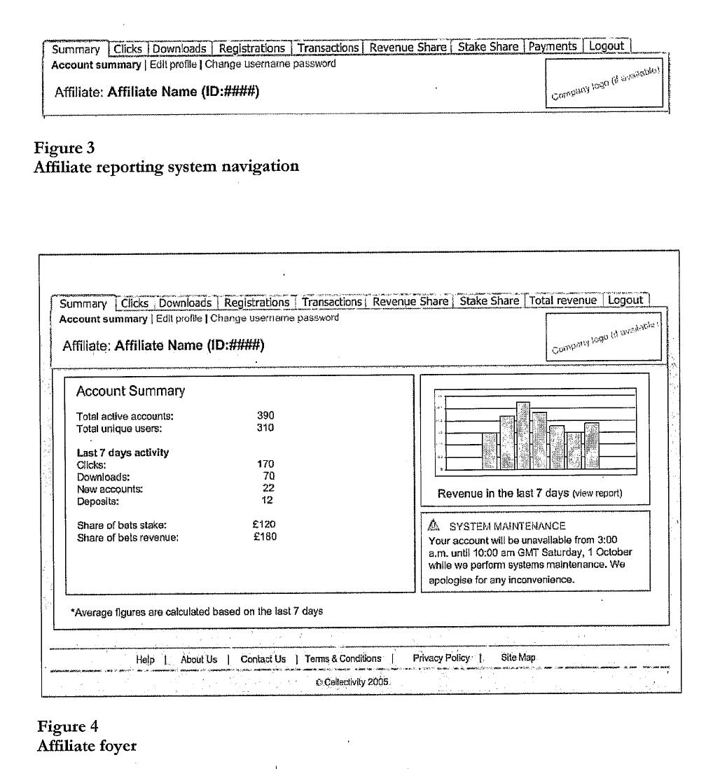

The navigation between the various sections will be tab based across the top of the screen, any sub menus relevant to each section will be displayed as links below the tabs. Each page will include the company name, affiliate id and company logo (if available), the navigation will be similar to the FIG. 3 diagram.

Affiliates will only be able to see tabs, which are relevant to their deal structures.

Once the affiliates have logged in successfully, they will be presented a summary screen giving them an overview of their account.

The screen will look similar to the FIG. 4 diagram.

Affiliates will be able to edit their affiliate profiles (contact details, URLs etc) as well as their username and password.

Their account summary will display:
Total active accounts
Total unique users
Clicks (last 7 days)
Downloads (last 7 days)
New accounts last 7 days)
Deposits (last 7 days)
Share of bets stake
Share of bets revenue

Within the foyer page there will be a graph indicating the overall revenue in the last 7 days and a window, which can be used by Cellectivity to post any communication to the affiliates, such as scheduled down time, or new feature introductions.

Within each reporting section the dates for which the reports will be customisable. There will be a shortcut date selection box, which will contain:
This month—default value
Last month
Last 7 days
Last week (Mon-Sun)
Last business week (Mon-Fri)

Or alternatively the user will be able to select between any dates they wish using a date picker drop down boxes. The reports within the date ranges will be broken down per day.

There will be the ability to view each report as a printer friendly version or export to CSV or Excel.

Clicks Reporting

If the affiliate is enabled to be paid per click they will be able to view the clicks report and see how much revenue they have generated over the selected date range.

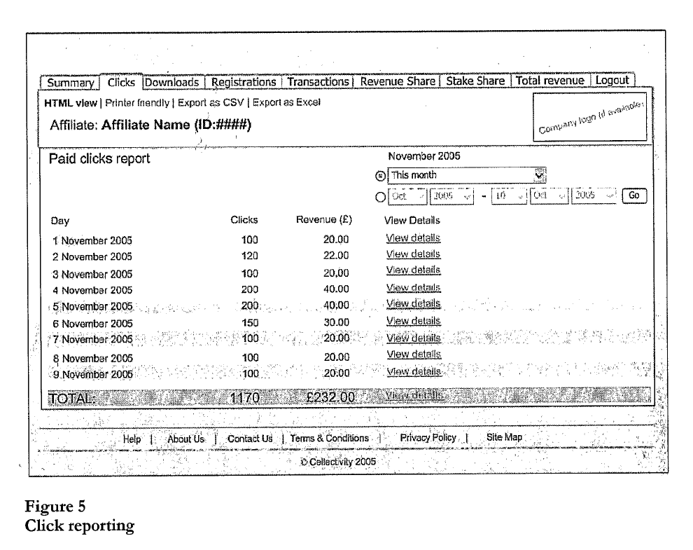

The report will look similar to the FIG. 5 diagram.

On each line there will be a ‘view details’ link which will display the different click prices for the day, which sum up to the total figure.

Downloads Reporting

If the affiliate is enabled to be paid per download they will be able to view the downloads report and see how much revenue they have generated over the selected date range.

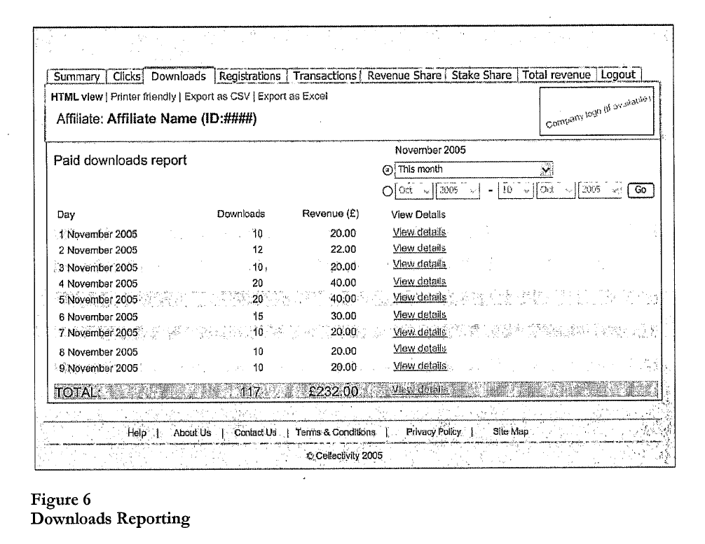

The report will look similar to the FIG. 6 diagram below.

FIG. 4.1.1.1: Downloads Reporting

On each line there will be a ‘view details’ link which will display the different download prices for the day, which sum up to the total figure.

Registrations Reporting

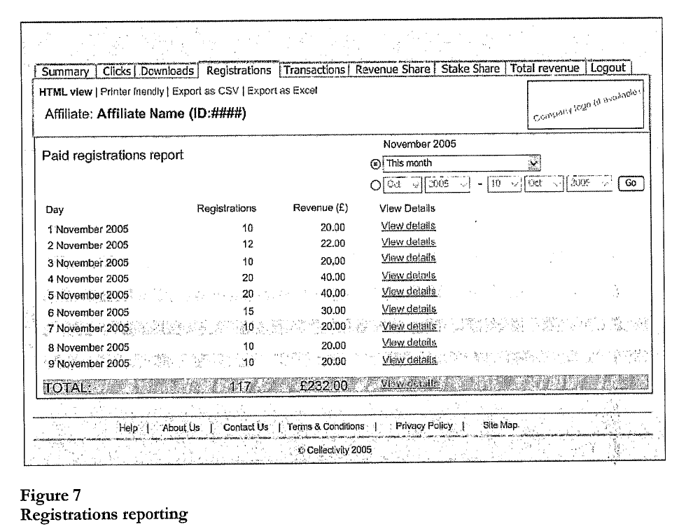

If the affiliate is enabled to be paid per registration they will be able to view the registrations report and see how much revenue they have generated over the selected date range. The report will look similar to the FIG. 7 diagram.

On each line there will be a ‘view details’ link which will display the different download prices for the day, which sum up to the total figure.

Revenue Share

If the affiliate is enabled to be paid on an on going revenue share they will be able to view the revenue share report and see how much revenue they have generated over the selected date range.

Since this report will be compiled based on figures provided by merchants, it may be incomplete and unconfirmed for some days, if those days exist in the selected date range there will be an appropriate notice displayed. Additionally each line within the report will be marked as confirmed or not.

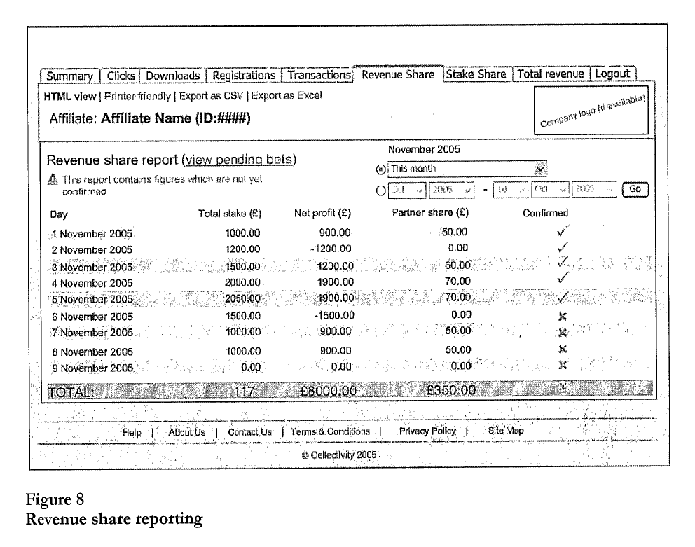

The report will look similar to the FIG. 8 diagram.

The above report will only include figures for bets on events, which have completed and the outcome is known. Events, which have not yet completed and the outcome is unknown will be marked as pending bets and will be included in a separate report. The revenue for them will be recognised in the month they complete.

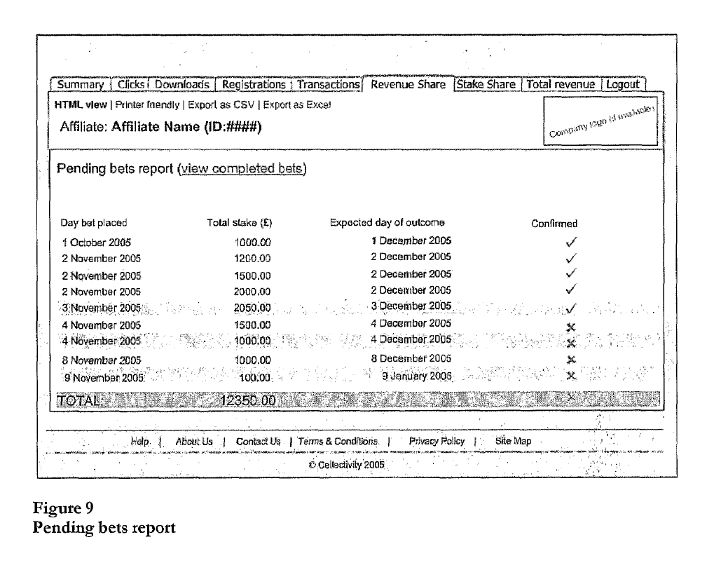

The pending bets report will look similar to the FIG. 9 diagram.

Since the report will only display the current pending bets it will not include a date filter.

Stake Share

If the affiliate is enabled to be paid on an on going revenue share of the stake they will be able to view the revenue share report and see how much revenue they have generated over the selected date range.

For this report to be complete it will need to be amended with figures, which are provided by merchants, it may be incomplete and unconfirmed for some days, if those days exist in the selected date range there will be an appropriate notice displayed.

Additionally each line within the report will be marked as confirmed or not.

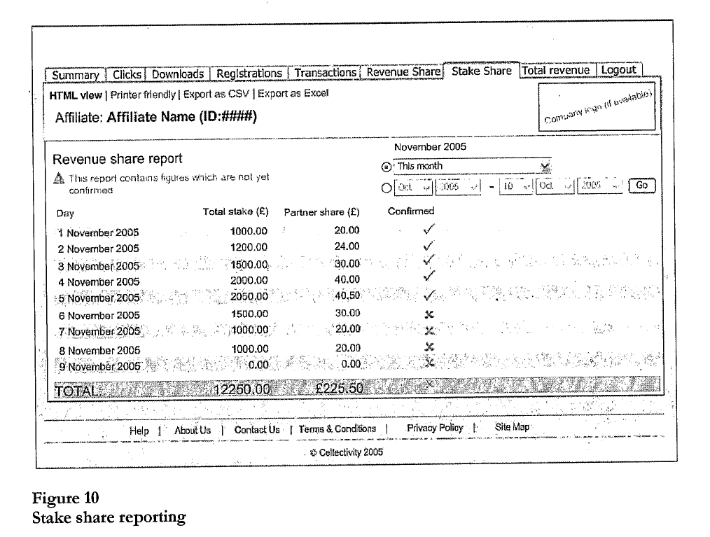

The report will look similar to the FIG. 10 diagram.

Total Revenue Report

The total revenue report will combine all figures together and once all figures for the month are updated and confirmed it will be used by the affiliates for invoicing.

The payment history link will enable the affiliate to view any previous invoices and their status. The available date ranges for this report will only be monthly as the affiliate payments are only issued on a monthly basis.

1. A method of enabling traffic to be driven to an e-commerce site, and that traffic to be tracked, the traffic relating to interactions between the e-commerce site and a mobile wireless device; the method comprising the steps of:
(a) an entity registering as an affiliate of the e-commerce site and publishing information that promotes that e-commerce site;
(b) an end-user seeing that information and as a consequence sending, or causing to be sent, a request to a remote server that can interact with the e-commerce site under control inputs from an application running on the device, the request including data that uniquely defines the affiliate.

2. The method of claim 1 in which the information is published offline.

3. The method of claim 2 in which the information that is published offline is a unique identifier comprising at least a destination number, the unique identifier being associated with both the given e-commerce site and the entity; and
(a) the end-user uses the mobile wireless device to send a message to the destination number to initiate an interaction with the e-commerce site;
(b) a remote server then interacts directly with the e-commerce site but enables the end-user to interact only indirectly with that site using the downloaded application;
(c) the identity of the entity is verified using the unique identifier.

4. The method of claim 3 in which the unique identifier is a unique code or text, as well as the destination number.

5. The method of claim 3 in which the unique text is conceptually related to the goods or services offered by the e-commerce site.

6. The method of claim 3 in which the unique identifier is sent by the mobile wireless device as a SMS to the destination number.

7. The method of claim 2 in which the information is published in a magazine, newspaper, billboard or other print media.

8. The method of claim 3 in which the entity can interact directly with an affiliates management system associated with the e-commerce site to obtain or define the unique identifier.

9. The method of claim 1 in which the information is published on-line.

10. The method of claim 9 in which the information that is published on-line includes an icon, button or other user selectable feature that, when selected, causes the application to be downloaded to the mobile wireless device.

11. The method of claim 10 in which selecting the user selectable feature also fetches an implementation page that explains how the user should install the application on the mobile wireless device.

12. The method of claim 9 in which the data that uniquely defines the affiliate is a URL tracking code.

13. The method of claim 1 in which the information is published in a WAP site and the end-user views that site using a WAP browser on the mobile wireless device.

14. The method of claim 13 in which the information that is published in the WAP site includes a hyperlink that, when selected, causes the application to be downloaded to the mobile wireless device.

15. The method of claim 13 in which the data that uniquely defines the affiliate is a URL tracking code.

16. The method of claim 1 in which the request is sent to a remote server that stores the number of the mobile wireless device of the end-user in association with a tracking code that links a user to a specific affiliate.

17. The method of claim 16 in which the remote server sends the application to the mobile wireless device, which the device loads to enable the end-user to interact indirectly with the e-commerce site.

18. The method of claim 17 in which the application is a J2ME application.

19. The method of claim 16 in which the remote server can identify a specific marketing campaign/promotion that the affiliate has initiated.

20. The method of claim 16 in which the remote server can interact directly with an affiliates management system associated with the e-commerce site.

21. The method of claim 20 in which the affiliates management system causes a payment to be made to the entity that operates the remote server when pre-defined kinds of interactions occur between the end-user and the e-commerce site.

22. The method of claim 21 in which the affiliates management system causes a payment to be made to a specific affiliate when pre-defined kinds of interactions occur between the end-user and the e-commerce site that arise from the information that affiliate published.

23. The method of claim 22 in which the affiliates management system allows the e-merchant and any affiliates to monitor or track the success and activity of any specific marketing campaign.

24. The method of claim 16 in which an e-commerce merchant publishes a web traffic affiliate program online and any potential affiliate can register online with that program not only for conventional web traffic promotion but also in relation to interactions from mobile wireless devices mediated by the remote server.

25. The method of claim 1 in which the application loads onto the mobile wireless device and provides a user interface that enables the end-user to interact indirectly with the e-commerce site.

26. The method of claim 25 in which the user interface is created by a presentation layer that allows customisation of the user interface for any different e-commerce site.

27. The method of claim 25 in which a remote server remotely interrogates one or more e-commerce sites in response to information requests from the application loaded onto the mobile wireless device.

28. The method of claim 27 in which the remote server can not only parse data on the site but also interact with transactional flows or routines of that site.

29. The method of claim 27 in which the remote server includes a query engine which operates on XML format data obtained from content data extracted from the e-commerce site, the query engine parsing the XML format data into SAX events which are then queried by the query engine.

30. The method of claim 27 in which the remote server allows the end-user to interact indirectly with the e-commerce site, including undertaking one or more of the following: account creation, login/out, searching, browsing, account maintenance, purchasing.

31. The method of claim 30 in which the interaction from the remote server requires no adaptation of an existing e-commerce site.

32. The method of any preceding claim 1 in which the request includes a request for the application to be downloaded to the mobile wireless device.

33. The method of claim 1 in which the application is already installed on the device.

34. The method of claim 1 in which the request sent by the end-user also uniquely identifies a campaign or product being promoted by the affiliate.

35. The method of claim 1 in which the traffic that is driven to the e-commerce site includes traffic relating to one or more of: the end-user visiting the e-commerce site; the end-user registering with the e-commerce site; the end-user purchasing goods or services from the e-commerce site.

36. A printed publication that promotes an e-commerce site and is controlled by an entity that is an affiliate of that e-commerce site, the publication including a unique identifier that, when sent, or caused to be sent, by an end-user to a remote server using a mobile wireless device, uniquely defines the affiliate.

37. (canceled)

38. (canceled)

39. A mobile wireless device when programmed with an application downloaded because of an interaction with the printed publication, web site or WAP site as defined in claim 1.

40. (canceled)

41. (canceled)
